(19) United States
(12) Patent Application Publication
(10) Pub. No.: US 2018/0371151 A1
(43) Pub. Date: Dec. 27, 2018

(54) NOVEL HYDROXY-TERMINATED (PER)FLUOROPOLYETHER-URETHANE POLYMERS AND THEIR USE IN CLEAR-COAT COMPOSITIONS

(71) Applicant: SOLVAY SPECIALTY POLYMERS ITALY S.P.A., Bollate (IT)

(72) Inventors: Giovanni SIMEONE, Solaro, Milano (IT); Pier Antonio GUARDA, Arese (IT); Silvia Rita PETRICCI, Bresso (IT)

(21) Appl. No.: 15/775,617

(22) PCT Filed: Nov. 10, 2016
(86) PCT No.: PCT/EP2016/077216

§ 371 Date: May 11, 2018

(30) Foreign Application Priority Data
Nov. 11, 2015 (EP) 15194010.3

(51) Int. Cl. C08G 18/50; C08G 18/75; C08G 18/24; C08G 18/32; C09D 175/08

(52) U.S. Cl. CPC C08G 18/5015; C08G 18/755; C09D 175/08; C08G 18/3206; C08G 18/246

(57) ABSTRACT

The present invention relates to novel hydroxy-terminated (per)fluoropolyether polymer derivatives comprising urethane moieties and their use as additive in compositions for coating substrates, notably glass, metal and plastic.

### CROSS REFERENCE TO RELATED APPLICATIONS

This application claims priority from European application No. 15194010.3 filed on 11 Nov. 2015, the whole content of this application being incorporated herein by reference for all purposes.

### TECHNICAL FIELD

The present invention relates to novel hydroxy-terminated (per)fluoropolyether polymer derivatives comprising urethane moieties and their use as additive in compositions for coating substrates, notably glass, metal and plastic.

### BACKGROUND ART

In the automotive industry, multi-layer coatings are used that typically comprise a cathodic e-coating, which protects from corrosion and provides a basis for applying the subsequent paint layers; a primer, which allows to provide a smoother surface and protects from UV-radiation, heat differences and stone-chipping; a base coat layer, which is a colour- and/or special effect-imparting base coat layer and contains the visual properties of colour end effects; and an outer clear coat layer, that forms the final interface with the environment.

The clear coat has both a decorative and a protective function, enhancing the shine and durability of the base coat layer, and at the same time it must provide specific properties to the substrate, including notable resistance to abrasion, easy-to clean and anti-finger print properties.

Easy-to-clean coating compositions have been disclosed in the art, which exhibit good initial self-cleanability due to a surface enrichment of hydrophobic substances in the coating layer, for example in U.S. Pat. No. 5,597,874 (E.I. DU PONT DE NEMOURS AND COMPANY), U.S. Pat. No. 5,705,276 (E.I. DU PONT DI NEMOURS AND COMPANY) and US 2014/0364542 (AXALTA COATING SYSTEM IP CO., LLC).

EP 1874841 B (BASF COATINGS GMBH) discloses aqueous preparation for coating substrate surfaces comprising

i) 20 to 80 wt. % of water,
ii) 10 to 75 wt % of polyurethane compound present in dispersed form,
iii) 0 to 30 wt. % of dispersed mineral particles, and
iv) 0 to 50 wt. % of a polymer component which is present in dispersed form, is different from the polyurethane compound ii) and is present in terms of copolymers or homopolymers or mixtures thereof,
where
the polyurethane compound ii) has polyol and isocyanate structural units linked in the manner of a urethane bond; 1 to 50 wt. % of the polyol structural units originate from polyadducted polyols which have one or more fluorine-containing substituents and also have two or more isocyanate-reactive hydroxyl groups; at least 50 wt. % of the isocyanate structural units originate from polyadducted polyisocyanate, polyisocyanate derivative and/or polyisocyanate homologues having in each case two or more aliphatic or aromatic isocyanate groups, or mixtures thereof; and the dispersed mineral particles iii) comprise colourless or white metal oxide in the form of ZnO and/or TiO₂;
characterized in that at least 50 wt. % of the overall metal oxide particles iii) have a particle size of not more than 500 nm (measurement standard for the determination of the particle size: DIN 53206; after dispersing of the particles in water via ultrasound; measurement by photon correlation spectroscopy).

The fluorine-containing substituents of the polyol structural units are present in the form of substituents of the general formula

F(CF₂)ₓ—(CH₂)_{y}—

wherein x=4-20 and y=1-6; and/or

CF₃—CF₂CF₂O—(CF(CF₃)CF₂O)_{z}—CF(CF₃)—CH₂—

wherein z is 1-10.

However, this document discloses neither compositions comprising the (per)fluoropolyether polymer derivatives according to the present invention, nor their use as additives in compositions for clear coatings.

EP 0695772 A (AUSIMONT S.P.A.) discloses (per)fluoropolyether cured polymers comprising urethane moieties and their use as anti-graffiti.

Before curing, the PFPE polymers have hydroxylic polyfunctional terminals of general formula:

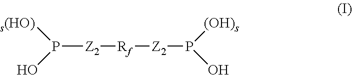

wherein
Z₂ represents the bifunctional group —O—CO—NH—R—NH—CO—O—, R being an alkylene radical from 1 to 20 carbon atoms,
Rf represents the R′f-Y′ group wherein R′f is a bifunctional radical derived from (per)fluoropolyethers and Y′ is a bivalent linking organic group;
s is an integer equal to 1 or 2;
P represents a trivalent or tetravalent radical derived from polyols.

More in particular, the polymer disclosed in Example 1 is obtained by reacting Fomblin® Z-DOL (i.e., a PFPE having two chain ends both comprising —OH groups) in a first step with a diisocyanate compound and in a second step with trimethylolpropane, such that the ratio between the total number of equivalents of —OH groups (deriving from the starting PFPE polymer and the polyol used in the second step) and the total equivalents of isocyanate groups (—N═C═O) is 2.

U.S. Pat. No. 8,728,623 (3M INNOVATIVE PROPERTIES COMPANY) discloses hard-coat coating composition comprising a perfluoropolyether urethane additive and a silicone (meth)acrylate additive. More in particular, this document discloses articles comprising a substrate having a surface layer comprising the reaction product of a mixture comprising: i) a hydrocarbon-based hard-coat composition; and ii) at least one perfluoropolyether urethane additive having a perfluoropolyether moiety and at least one free-radically reactive group. The perfluoropolyether urethane additive is made by first reacting a polyisocyanate with a perfluoropolyether compound containing an alcohol, thiol or amine group; this additive is then combined with a isocyanate reactive multifunctional free-radically polymerizable (meth)acrylate cross-linker. The perfluoropolyether herein disclosed are prepared from an isocyanate reactive HFPO-material, wherein “HFPO—” refers to end groups of formula F(CF(CF₃)CF₂O)ₐ—CF(CF₃)— of the methyl ester F(CF(CF₃)CF₂O)ₐ—CF(CF₃)C(O)OCH₃ wherein a averages 2 to 15.

Thus, this document teaches to use mono-functional compounds comprising branched recurring units having 2 or 3 carbon atoms but it does not disclose additives comprising moieties deriving from di-, tri- or tetraol compound(s) having low molecular weight, such as lower than 400.

EP 0379462 A (CIBA-GEIGY AG) discloses vinylic macromers containing perfluoropolyalkylether and polyalkylether segments, polymers and ophthalmic devices made therefrom, and crosslinked copolymers of (a) said vinylic comonomers containing perfluoropolyalkylether and polyalkylehter segments with (b) minor amounts of vinylic comonomers and ophthalmic devices made therefrom. According to this patent application, a method for manufacturing the vinylic macromers comprises three steps:
(I) reacting a perfluoropolyalkylether dialkanol of the formula OHCH₂(CₐF₂ₐO)_{b}(CF₂)CH₂OH with two moles of a difunctional reactive agent, e.g. a diisocyanate of the formula OCN—R—NCO in the presence of a urethane catalyst to form the corresponding end group containing endcapped derivative Z₁—(NCO)₂ wherein Z₁ is a moiety containing a perfluoropolyalkylether segment;
(II) reacting the resulting endcapped perfluopolyalkylether derivative Z₁—(NCO)₂ with two moles of a polyoxyalkylene diol of the formula HO(CₘH₂ₘO)ₙ₊₁—H to form the corresponding triblock derivative of formula Z₁[NH—C(O)O(CₘH₂ₘO)ₙ₊₁—H]₂; and
   (III) reacting the triblock derivative with two moles of reactive group containing vinylic monomer wherein the reactive group is isocyanate.

WO 96/31792 (CIBA-GEIGY AG, COMMONWEALTH SCIENTIFIC AND INDUSTRIAL RESEARCH ORGANISATION) discloses polymeric materials useful in optic and ophthalmic arts. In particular, Example B-1 discloses the synthesis of a macromer that comprises the reaction between a 50 mmol of perfluoropolyether Fomblin® ZDOL containing 1.96 meq/g of hydroxyl groups), 0.1 mol of isophorone diisocyanate and alfa-omega-hydroxypropyl-terminated polydimethoxysilane containing 1.00 meq/g of hydroxyl groups. The intermediate polymer thus obtained is further reacted with 2-isocyanatoethyl methacrylate (IEM) and with a three-block copolymer polisiloxane-perfluoropolyether-polysiloxane, thus obtaining a macromere that is then reacted in Examples B-5, B-6, etc. with a compound bearing methacrylate group and UV cured, thus obtaining lenses for ophthalmic use.

Both the above mentioned patent applications in the name of CIBA, relates to the production of ophthalmic lenses. In order to provide a polymer suitable for the manufacture of contact lenses and ophthalmic devices, bi-functional polymers must be used, i.e. polymers terminating at both their chain ends with one functional group. Polymers having these characteristics are obtained only if the intermediate polymers obtained after each and every synthetic steps are also bi-functional. To this aim, it is necessary that the ratio between the total number of equivalents of —OH groups and the total number of equivalents of isocyanate groups is at least 2, i.e. 2 or higher than 2. Accordingly, none of the above cited patent application to CIBA discloses polymers obtained by a process wherein the ratio between the equivalents of —OH groups and the equivalents of isocyanate groups is higher than 1 and lower than 2.

US 20060167206 (CONSTR RES & TECH GMBH) discloses a fluorine-modified polyurethane resin that are said useful to produce coating systems and/or surfaces having very low surface tensions and very high contact angles.

### SUMMARY OF INVENTION

The Applicant faced the problem to provide coating compositions for substrates, including metal, glass and plastic substrates, which provides a transparent coating together with outstanding water- and oil-repellency, easy to clean and stain removal properties, as well as anti-fingerprint performances.

The Applicant tested the polymer disclosed in Example 1 of EP 0695772 cited above but such a polymer did not provide transparent coatings.

Then, the Applicant surprisingly found that PFPE polymer derivatives obtained by reacting a hydroxy-terminated PFPE polymer first with a diisocyanate compound and then with at least one polyol, such that a specific ratio between the total number of equivalents of —OH groups and the total equivalents of isocyanate groups is achieved, can be used as additives in clear coating compositions without affecting the transparency of the coating thus obtained.

Thus, in a first aspect, the present invention relates to a hydroxy-terminated (per)fluoropolyether polymer [polymer (P)] obtained by a process comprising the following steps:

(a) reacting a (per)fluoropolyether (PFPE) polymer comprising a (per)fluoropolyether chain [chain R_{pf}] having two chain ends, wherein at least one chain end comprises at least one hydroxy group [polymer P*] with at least one isocyanate compound [compound NCO] and
(b) reacting the intermediate compound obtained in step (a) with at least one di-, tri- or tetraol compound [compound OH],
wherein the ratio between the total number of equivalents of —OH groups deriving from said polymer P* and said at least one compound OH and the total number of equivalents of isocyanate groups deriving from said compound NCO is higher than 1 and lower than 2.

In a second aspect, the present invention relates to a composition [composition S] comprising:

A) from 0.01 to less than 5 wt. %, preferably from 0.05 to 4 wt. % and even more preferably from 0.1 to 2.5 wt. %, based on the total weight of said composition, of at least one polymer (P) as defined above;
B) from 5 to 50 wt. % based on the total weight of said composition of at least one binder component;
C) from 30 to 80 wt. % of at least one cross-linker component; and
D) optionally further ingredients.

In a third aspect, the present invention relates to the use of said composition (S) for coating at least one surface of a substrate, said substrate being preferably selected from glass, plastic and metal.

In a fourth aspect, the present invention relates to a method for coating at least one surface of a substrate, preferably selected from plastic, metallic or glass, said method comprising:

(i) contacting a substrate with said composition (S) and
(ii) drying said composition (S) onto said substrate.

More preferably, said method is method for obtaining a transparent coating onto at least one surface of a substrate as defined above.

Advantageously, the coating obtained with the composition (S) according to the present invention in addition to being transparent, it provides outstanding water- and oil-repellency, easy to clean and stain removal properties, as well as anti-fingerprint performances to the substrate onto which it is applied.

### DESCRIPTION OF EMBODIMENTS

For the purpose of the present description and of the following claims:
the use of parentheses around symbols or numbers identifying the formulae, for example in expressions like “polymer (P)”, etc., has the mere purpose of better distinguishing the symbol or number from the rest of the text and, hence, said parenthesis can also be omitted;
the acronym “PFPE” stands for “(per)fluoropolyether” and, when used as substantive, is intended to mean either the singular or the plural from, depending on the context;
the term “(per)fluoropolyether” is intended to indicate fully or partially fluorinated polymer;
the term “functionality” indicates the average number of functional groups, notably of groups —OH per polymer molecule and can be calculated for example as disclosed in EP 1810987 A (SOLVAY SOLEXIS S.P.A);
the terms “clear” and “transparent” are used as synonyms;
the expression “3- to 7-membered aliphatic ring” is intended to indicate divalent moieties deriving from cyclopropane, cyclobutane, cyclopentane, cyclohexane and cycloheptane;
the expression “5- to 10-membered aromatic ring” is intended to indicate any cyclic moiety derived from an aromatic compound and comprising from 5 to 10 members in the cyclic moiety;
the expression “aromatic compound” indicates any cyclic compound having a number of π electrons equal to 4n+2, wherein n is 0 or any positive integer, such as for example benzene, naphthalene, pyridine, quinoline, isoquinoline, pyrazine, pyrimidine, furan, benzofuran, pyrrole, indole, thiophene, benzothiophene, imidazole, benzimidazole, pyrazole, benzoxazole, isoxazole, benzisoxazole, thiazole, benzothiazole.

Suitable polymers P* are commercially available from Solvay Specialty Polymers (Italy) and can be obtained according to the methods disclosed in EP 1810987 A (SOLVAY SOLEXIS S.P.A.), EP 1614703 A (SOLVAY SOLEXIS S.P.A.) and WO 2014/090649 (SOLVAY SPECIALTY POLYMERS ITALY S.P.A.).

Preferably, said polymer P* comprises one chain (R_{pf}) having two chain ends, wherein both chain ends comprise at least one —OH group.

Preferably, said chain (R_{pf}) is a chain of formula -D-(CFX)ₐO(R_{f})(CFX′)_{b}-D-, wherein

a and b, equal or different from each other, are equal to or higher than 1, preferably from 1 to 10, more preferably from 1 to 3;
X and X′, equal or different from each other, are —F or —CF₃,
provided that when a and/or b are higher than 1, X and X′ are —F;
D and D*, equal or different from each other, are a divalent alkyl chain comprising from 1 to 20, more preferably from 1 to 6 and even more preferably from 1 to 3 carbon atoms, said alkyl chain being optionally interrupted by at least one oxygen atom and/or optionally substituted with at least one hydroxy group and/or with a perfluoroalkyl group comprising from 1 to 3 carbon atoms;
(R_{f}) comprises, preferably consists of, repeating units R^{∘}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, H;
(iv) —CF₂CF₂CF₂CF₂O—;
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being chosen among the following: —CFXO—, —CF₂CFXO—, —CF₂CF₂CF₂O—, —CF₂CF₂CF₂CF₂O—, with each of each of X being independently F or CF₃ and T being a C₁-C₃ perfluoroalkyl group.

More preferably, a and b, equal or different from each other, are from 1 to 10, even more preferably from 1 to 3.

More preferably, D and D*, equal or different from each other, are a chain of formula —CH(CF₃)— or —CH₂(OCH₂CHW)ₙ— wherein

n is 0 or an integer from 1 to 20, more preferably from 1 to 10, even more preferably from 1 to 5 and
W is a hydrogen atom or alkyl having from 1 to 3 carbon atoms, preferably methyl.

Preferably, chain (R_{f}) complies with the following formula:

—[(CFX¹O)_{g1}(CFX²CFX³O)_{g2}(CF₂CF₂CF₂O)_{g3}(CF₂CF₂CF₂CF₂O)_{g4}]— (R_{f}-I)

wherein
X¹ is independently selected from —F and —CF₃,
X², X³, equal or different from each other and at each occurrence, are independently —F, —CF₃, with the proviso that at least one of X is —F;
g1, g2, g3, and g4, equal or different from each other, are independently integers ≥0, such that g1+g2+g3+g4 is in the range from 2 to 300, preferably from 2 to 100; should at least two of g1, g2, g3 and g4 be different from zero, the different recurring units are generally statistically distributed along the chain.

More preferably, chain (R_{f}) is selected from chains of formula:

—[(CF₂CF₂O)ₐ₁(CF₂O)ₐ₂]— (R_{f}-IIA)

wherein:
a1 and a2 are independently integers ≥0 such that the number average molecular weight is between 400 and 10,000, preferably between 400 and 5,000; both a1 and a2 are preferably different from zero, with the ratio a1/a2 being preferably comprised between 0.1 and 10;

—[(CF₂CF₂O)_{b1}(CF₂O)_{b2}(CF(CF₃)O)_{b3}(CF₂CF(CF₃)O)_{b4}]— (R_{f}-IIB)

wherein:
b1, b2, b3, b4, are independently integers ≥0 such that the number average molecular weight is between 400 and 10,000, preferably between 400 and 5,000; preferably b1 is 0, b2, b3, b4 are >0, with the ratio b4/(b2+b3) being ≥1;

—[(CF₂CF₂O)_{c1}(CF₂O)_{c2}(CF₂(CF₂)_{cw}CF₂O)_{c3}]— (R_{f}-IIC)

wherein:
cw=1 or 2;
c1, c2, and c3 are independently integers ≥0 chosen so that the number average molecular weight is between 400 and 10,000, preferably between 400 and 5,000; preferably c1, c2 and c3 are all >0, with the ratio c3/(c1+c2) being generally lower than 0.2;

—[(CF₂CF(CF₃)O)_{d}]— (R_{f}-IID)

wherein:
d is an integer >0 such that the number average molecular weight is between 400 and 10,000, preferably between 400 and 5,000;

—[(CF₂CF₂C(Hal*)₂O)ₑ₁—(CF₂CF₂CH₂O)ₑ₂—(CF₂CF₂CH(Hal*)O)ₑ₃]— (R_{f}-IIE)

wherein:
Hal*, equal or different at each occurrence, is a halogen selected from fluorine and chlorine atoms, preferably a fluorine atom;
e1, e2, and e3, equal to or different from each other, are independently integers ≥0 such that the (e1+e2+e3) sum is comprised between 2 and 300.

Still more preferably, chain (R_{f}) complies with formula (R_{f}-III) here below:

—[(CF₂CF₂O)ₐ₁(CF₂O)ₐ₂]— (R_{f}-III)

wherein:
a1, and a2 are integers >0 such that the number average molecular weight is between 400 and 10,000, preferably between 400 and 5,000, with the ratio a1/a2 being generally comprised between 0.1 and 10, more preferably between 0.2 and 5.

Preferably, said compound NCO is a compound of general formula R(NCO)—_{z} wherein R has the same meanings defined above for polymer P and z is 2 or 3.

Preferred compounds NCO are those wherein z is 2, also referred to as “diisocyanate compounds”.

Suitable diisocyanate compounds include for example aliphatic and aromatic isocyanate, selected in the group comprising: 1-isocyanate-3-isocyanate-methyl-3,5,5-trimethylcyclohexane (also referred to as isophoronediisocyanate—IPDI); hexamethylene diisocyanate (HDI); dichloro-hexamethylene-diisocyanate; ethylidene-di-isocyanate; butylene-diisocyanate; pentamethylene diisocyanate; cyclohexylene-1,2-diisocyanate; cyclopentylene-1,3-diisocyanate; cyclohexylene-1,4-diisocyanate; xylene-diisocyanate; 1,2-diisocyanate-methyl-cyclobutane; 1-methyl-2,4-diisocyanate-cyclohexane, 1-methyl-2,6-diisocyanate cyclohexane; aliphatic diisocyanates containing ether groups, such as 1,3-bis(Y-isocyanatepropoxy)-2,2-dimethylpropane; isomers of trimethyl-1,6-diisocyanato-hexane such as 2,2,4-trimethylhexamethylene diisocyanate, 2,4,4-trimethylhexamethylene diisocyanate and mixtures thereof; isomers of methylene-bis(cyclohexyl isocyanate) [also referred to as hydrogenated MDI] such as 4,4′-dicyclohexyl-methanediisocyanate optionally in admixture with further isomers; isomers of methylene diphenyl diisocyanate (MDI) such as 2,2′-MDI, 2,4′-MDI and 4,4′-diphenyl-methane diisocyanate (4,4′-MDI) and mixtures thereof; isomers of toluene diisocyanate (TDI) such as 2,4-toluene-diisocyanate (2,4-TDI) and 2,6-toluenediisocyanate (2,6-TDI), and mixtures thereof.

Aliphatic diisocyanates are particularly preferred. Good results have been obtained with isophoronediisocyanate.

In step (a), the ratio between the equivalents of —OH groups deriving from polymer P* and the equivalents of isocyanate groups deriving from compound NCO is higher than 2, more preferably higher 2 and lower than 10 and even more preferably higher than 2 and lower than 7.

Preferably, step (a) is performed under heating at a temperature of from 40° C. to 100° C. Preferably, heating is performed until the mixture turns limpid. The skilled person can determine the duration of the heating depending on the starting materials and on the reaction conditions.

Preferably, step (a) is performed in the presence of an organic solvent, for example selected in the group comprising: ketones for instance methylethylketone (MEK), methylisobutylketone (MIBK); esters for instance ethyl acetate, butyl acetate, isobutyl acetate; organic solvents containing in the molecule an ester-ether group such as polyoxyethylene monoethyl-ether acetate, polyoxyethylene monobutylether acetate, polyoxy butylene mono-ethyl-ether acetate, polyoxy-butylene monobutylether acetate, polyoxyethylene diacetate, polyoxybutylene-diacetate, 2-ethoxy ethylacetate, ethyleneglycol diacetate, butyleneglycol diacetate. Esters are particularly preferred. Good results have been obtained by using butyl acetate.

Preferably, step (a) is performed in the presence of a catalyst, in order to increase the reaction kinetic. Preferred catalysts are selected in the group comprising tertiary amines, such as tryethylendiamine, N-ethyl-ethylene-imine, tetramethylguanidine, dimethylcyclohexylamine; organometallic catalysts, such dibutyltindilaurate (DBTDL), octoate tin, naphthenate cobalt, acetylacetonate vanadium, dimethyl-tin-diethyl-hexanoate and blends thereof, organic ester salts of zirconium, zinc, titanium and bismuth. Organometallic catalysts are particularly preferred. Good results have been obtained by using dibutyltin-dilaurate.

Said catalyst are used in an amount not higher than 0.5 wt. % based on the total weight of the reaction mixture.

Preferably, step (b) is performed by reacting at least one compound OH comprising two —OH groups (also referred to as “diol compound”) and/or at least at least one compound comprising three —OH groups (also referred to as “triol compound”) and/or at least one compound OH comprising four —OH groups (also referred to as “tetraol compound”).

Preferably, said compound OH has a molecular weight lower than 400. More preferably, said compound OH is selected in the group comprising trimethylolpropane, 2,2,-dimethyl-1,3-propandiol, ethylene glycol, glycerol, 2,2,-bis(hydroxymethyl)-1,3-propandiolpropylene glycol, and mixtures thereof.

Preferably, step (b) is performed under heating at a temperature of from 40° C. to 100° C. The skilled person can determine the duration of the heating depending on the starting materials and on the reaction conditions.

Preferably, step (b) is performed in the presence of an organic solvent, which is preferably selected in the group listed above for step (a). Esters are particularly preferred. Good results have been obtained by using butyl acetate.

Preferably, a catalyst is used also in step (b). More preferably, said catalyst is selected in the group defined above for step (a) and even more preferably the catalyst used in step (b) is the same catalyst used in step (a).

Preferred embodiments of said polymer (P) are those obtained by reacting in step (a), said polymer P* with a diisocyanate compound.

According to a preferred embodiment, said polymer (P) comprises:
at least one fluorinated block comprising a (per)fluoropolyether chain [chain R_{pf}],
at least one end group bearing at least one hydroxy group [group OH],
a bridging group [group B] between said chain R_{pf} and said group OH, comprising
at least one moiety [moiety (Z)] of formula

—O—C(O)NH—R—NHC(O)—O—

wherein R is an alkyl chain having from 1 to 20 carbon atoms, a 3- to 7-membered aliphatic ring optionally substituted with at least one linear or branched alkyl chain having from 1 to 6 carbon atoms, a 5- to 10-membered aromatic ring optionally substituted with at least one linear or branched alkyl chain having from 1 to 6 carbon atoms, a group comprising two aliphatic or two aromatic rings as defined above linked together via an alkylene chain comprising from 1 to 3 carbon atoms, and
at least one di-, tri- or tetravalent alkyl chain [moiety (A)] having from 1 to 10 carbon atoms, optionally substituted with at least one substituent selected from the group comprising, preferably consisting of alkyl group having from 1 to 6 carbon atoms, hydroxy and alkoxy having from 1 to 3 carbon atoms.

Preferably, said chain (R_{pf}) has the same meanings defined above for polymer P*.

Preferably, said bridging group (B) complies with the following formula (B-I):

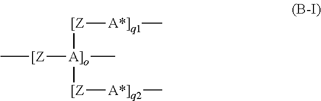

wherein
Z and A are as defined above,
A* has the same meanings defined above for A,
∘ is an integer from 1 to 10, more preferably from 1 to 6, and
q1 and q2, identical or different from each other, are 0 or an integer from 1 to 10, more preferably from 1 to 6.

In a preferred embodiment, in formula (B-I) above, moiety Z is linked to said chain R_{pf}, while moiety A is linked to said group OH. When present, also said at least one moiety A* links group OH.

In formula (I) above, moieties A* are represented as divalent moieties for simplicity. However, each of said moiety A* can be a di-, tri- or tetravalent alkyl chain as defined above for A.

Polymer (P-I) can comprise one or more chains (R_{pf}), preferably from 1 to 5 chains (R_{pf}).

When polymer (P) comprises more than one chain (R_{pf}), said chains (R_{pf}) are linked to each other through one moiety Z as defined above.

According to a preferred embodiment, said polymer (P) complies with formula (P-I):

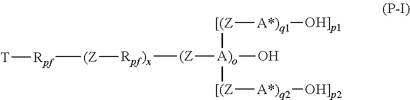

wherein
R_{pf}, Z, A, A*, ∘, q1 and q2 are as defined above;
x is 0 or an integer from 1 to 4;
p1 and p2, equal or different each other, are 0 or 1; and
T is a neutral group being selected in the group comprising —H, —F, —Cl, a straight or branched perfluoroalkyl group comprising from 1 to 3 carbon atoms, or a group of formula (T-I):

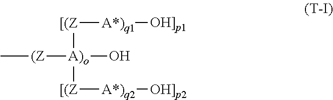

wherein Z, A, A*, ∘, q1, q2, p1 and p2 are as defined above.

According to a preferred embodiment, said group T is a group of formula (T-I) as defined above.

Preferably, the functionality (F) of polymer (P), i.e. the average number of groups —OH per molecule of polymer (P), is from 1 to 10, more preferably from 1 to 7 and even more preferably from 1 to 6.

Preferably, polymer (P) is obtained according to the synthesis disclosed above in the form of solid.

In this case, in order to be used as additive, a composition [composition (Sᵢ)], containing polymer (P) and a solvent is prepared. Preferably, said composition (Sᵢ) is in the form of a solution. Suitable solvents are selected from those listed above for step (a).

Preferably, said composition (Sᵢ) contains polymer (P) in an amount of from 1 to 99 wt. %, more preferably from 5 to 98 wt. % and even more preferably from 10 to 90 wt. % based on the total weight of said composition (Sᵢ), the remaining part to 100 wt. % being at least one solvent.

Preferably, said composition (S) comprises from 7 to 40 wt. %, more preferably from 10 to 30 wt. %, based on the total weight of said composition (S) of at least one binder component.

Preferably said binder component has a solids content of from 30 to 100 wt. % comprising at least one hydroxyl-functional binder and, optionally, a volatile organic content of from 0 to 70 wt. %, based on the total weight of the binder component.

Suitable hydroxyl-functional binders include for example hydroxyl-functional resins like polyurethane resins, (meth)acrylic polymer resins, polyester and polyether polyols including linear and branched polyester polyols. Branched polyester polyols are particularly preferred.

The expression “volatile organic content” refers to the sum of all volatile components, including organic solvents and organic additives, when presents.

Suitable organic solvents can be selected from the organic solvents conventionally used for coating compositions, such as for example glycol ethers and glycol esters, such as diethylene glycol dialkylethers, dipropylene glycol dialkylethers; glycol ether esters such as ethyl glycol acetate, butyl glycol acetate, methoxypropyl acetate; glycols such as propylene glycol and oligomers thereof; (poly)esters; N-methylpyrrolidone; ketones such as methyl ethyl ketone, acetone, cyclohexanone; alcohols such as propanol, butanol, hexanol; esters such as butyl acetate, isobutyl acetate; aromatic and aliphatic hydrocarbons such as toluene, xylene and linear or branched C₆ to C₁₂ hydrocarbons; (poly)acrylates; and mixtures thereof.

Suitable binder components are commercially available for example from Covestro under the trademark DESMOPHEN®.

Preferably, said composition (S) comprises from 45 to 70 wt. %, more preferably from 45 to 65 wt. %, based on the total weight of said composition (S) of at least one cross-linker component.

Suitable cross-linkers are selected in the group comprising polyisocyanate cross-linkers, trans-esterification cross-linking agents, amino resin cross-linking agents, such as melamine-formaldehyde resins; trisalkoxycarbonylaminotriazine cross-linking agents, and the like. Preferably, said cross-linker is a polyisocyanate cross-linker.

Preferably, said polyisocyanate cross-linker has a polyisocyanate content of from 40 to 100 wt. %, optionally in admixture with a volatile organic component in an amount of from 0 to 60 wt. % based on the total weight of said polyisocyanate cross-linker.

The polyisocyanate preferably comprise at least one aliphatic or aromatic polyisocyanate selected from the 1,6-hexane diisocyanate isocyanurate type and the isophorone diisocyanate isocyanurate type.

When present, the volatile organic component preferably comprises a solvent that is inert towards free isocyanate group, such as for example glycol ether esters, ketones; esters; aromatic or aliphatic hydrocarbons.

Suitable polyisocyanate components are commercially available from Covestro under the trademark DESMODUR®.

Suitable further ingredients are selected for example in the group comprising transparent fillers and volatile or non-volatile additives, for example binders, catalysts, leveling agents, wetting agents, anticratering agents, dyes, rheology control agents, antioxidants and/or light stabilizers.

Suitable transparent fillers include for example silica.

Each of said additional ingredient and additive is preferably used in conventional amounts, such as for example in an amount up to 8 wt. %, more preferably from 0.01 to 5 wt. %, even more preferably from 0.05 to 2 wt. % based on the total weight of composition (S).

Composition (S) can be prepared by
contacting at least one polymer (P) as defined above or composition (Sᵢ) as defined above with a base coating composition [composition S*]
   comprising at least one binder compound as defined above and optionally further ingredients,
optionally mixing;
adding said at least one cross-linker component; and
optionally mixing.

In an alternative embodiment, composition (S) can be prepared by
contacting at least one polymer (P) as defined above or composition (Sᵢ) as defined above with a base coating composition [composition S*]comprising at least one binder compound as defined above, at least one cross-linker compound as defined above and optionally further ingredients as defined above, and
optionally mixing.

Advantageously, the amount of said composition (Sᵢ) is such that the final composition (S) contains an amount of polymer (P) of from 0.01 to less than 5 wt. %, based on the total weight of composition (S).

Said mixing step(s) can be performed for example at room temperature. Traditional contacting or mixing methods can be employed, which require for example the use of a mechanical shaker or heating.

Composition (S) can be applied to the surface of a suitable substrate in order to form a clear (i.e. transparent) coating layer.

Preferably, a suitable substrate is selected from the group comprising, preferably consisting of, glass; metal, including aluminium, optionally coated with a base coat layer, such as a pigmented base coat layer; and plastic, including polycarbonate (PC), polyvinyl chloride (PVC), thermoplastic olefin (TPO), thermoplastic polyurethane (TPU), polypropylene (PP), acrylonitrile butadiene styrene (ABS) and polyamides (PA).

Said pigmented base-coat layer can be cured, partially cured or uncured and represents the colours and/or special effect-imparting coating layer.

More preferably, said substrate is suitable to be used in the automotive industry for the interior and/or the exterior of vehicles, notably cars. Automotive substrates include in particular car windows and mirrors, automotive bodies and automotive metal or plastic parts. Examples of automotive bodies include truck and vehicle bodies, such as passenger car bodies and van bodies. Examples of automotive body metal or plastic parts can include doors, bonnets, boot lids, hatchbacks, wings, spoilers, bumpers, collision protection strips, slide trim, sills, mirror housing, door handles and hubcaps.

Preferably, step (i) is performed by traditional methods, such as for example spraying said composition (S) onto said substrate.

Typically, the coating obtained after step (i) has a thickness of from 5 to 500 μm, more preferably from 10 to 250 μm, and even more preferably from 25 to 175 μm.

Preferably, step (ii) is performed by curing composition (S) onto said substrate.

The curing conditions depend on the ingredients of said composition (S) and from the circumstances under which the coating and curing process is carried out.

Good results have been obtained by heat-curing said composition (S).

Preferably, during said heat-curing step, the temperature is from 20° C. to 150° C.

Preferably, the curing time is from 5 to 120 minutes.

Advantageously, said step of curing comprise a first step of curing at a temperature of from 20 to 30° C. for a time of from 5 to 10 minutes and a second step of curing at a temperature of from 60° C. to 100° C. for a time of from 20 to 60 minutes.

Typically, the coating obtained after step (ii) has a thickness of from 1 to 250 μm, more preferably from 5 to 125 μm, and even more preferably from 10 to 100 μm.

Should the disclosure of any patents, patent applications and publications which are incorporated herein by reference conflict with the description of the present application to the extent that it may render a term unclear, the present description shall take precedence.

The invention will be herein after illustrated in greater detail by means of the Examples contained in the following Experimental Section; the Examples are merely illustrative and are by no means to be interpreted as limiting the scope of the invention.

### Experimental Section

### Materials

Desmophen® XP 5488: branched polyester polyol, solvent-free (binder) Desmodur® N3900: low-viscosity, aliphatic polyisocyanate resin based on hexamethylene diisocyanate (cross-linker).

Methoxypropylacetate;

dibutyltin dilaurate solution 1% w/w in butyl acetate (catalyst) were obtained from Sigma Aldrich.

R=ratio between the total number of equivalents of —OH groups and the total number of equivalents of isocyanate groups.

### Synthesis

### Polymer 1 (R=1.33)

124 g (0.074 moles) of Fomblin® Z-DOL PFPE of formula HOCH₂CF₂O(CF₂CF₂O)ₐ₁(CF₂O)ₐ₂.CF₂CH₂OH

having number average molecular weight Mn of 1680 (equivalent weight 840) and ratio a1/a2 of 1.2;

49.2 g (0.222 moles) of isophoronediisocyanate, 30 g of butyl acetate and 0.056 g of dibutyltin-dilaurate are charged, under nitrogen atmosphere, into a 500 cc reactor equipped with stirrer, thermometer and falling cooler. The mixture was then slowly heated in 30 minutes until reaching to 77° C. At this temperature, the mixture, initially lacteous, became limpid. The mixture was then heated at 80° C. and kept at this temperature for 1 hour. Then, it was cooled at 55° C. and 15.38 g (0.148 moles) of 2,2-dimethyl-1,3-propanediol and 6.60 g (0.049 moles) of trimethylolpropane dissolved at 60° C. in 54 g of butylacetate, were added. The mixture was then slowly heated again in 30 minutes to 80° C. and kept at this temperature for 3 hours, to obtain a solution having 70% by weight of product of polymer 1 having:
calculated average number molecular weight=1870; and
functionality (F)=2.5.

### Polymer 1C—Comparative (R=2)

Polymer 1C was prepared following the same procedure disclosed above for polymer 1, except that:
32.9 g (0.148 moles) of isophoronediisocyanate and
19.90 g (0.148 moles) of trimethylolpropane dissolved at 60° C. in 25 g of butylacetate
   were used; and
the synthesis was performed without the addition of
   2,2-dimethyl-1,3-propanediol, thus obtaining a product of formula (II); thus obtaining polymer (P-1C) having:
calculated average number molecular weight=2400;
functionality (F)=4.0.

Polymer 1C was used as comparative additive in the following examples, wherein it is indicated as P-1C.

### Polymer 2 (R=1.50)

124 g (0.074 moles) of Fomblin Z-DOL of formula HOCH₂CF₂O(CF₂CF₂O)ₐ₁(CF₂O)ₐ₂—CF₂CH₂OH

having number average molecular weight Mn of 1680 (equivalent weight 840) and ratio a1/a2 of 1.2;

65.6 g (0.295 moles) of isophoronediisocyanate, 30 g of butyl acetate and 0.056 g of dibutyltin-dilaurate are charged, under nitrogen atmosphere, into a 500 cc reactor equipped with stirrer, thermometer and falling cooler. The mixture was then slowly heated in 30 minutes until reaching to 77° C. At this temperature, the mixture, initially lacteous, became limpid. The mixture was then heated at 80° C. and kept at this temperature for 1 hour. Then, it was cooled at 55° C. and 15.38 g (0.148 moles) of 2,2-dimethyl-1,3-propanediol and 19.9 g (0.148 moles) of trimethylolpropane dissolved at 60° C. in 45 g of butylacetate, were added.

The mixture was then slowly heated again in 30 minutes to 80° C. and kept at this temperature for 3 hours, to obtain a solution having 70% by weight of product of polymer 2 having:
calculated average number molecular weight=3050; and
functionality (F)=4.0.

Polymer 2 was used as additive in the following examples, wherein it is indicated as P-2.

### Polymer 3 (R=1.71)

Polymer 3 was prepared following the same procedure disclosed above for polymer 2, except that the following reagents and amounts were used:
38.3 g (0.172 moles) of isophoronediisocyanate and
6.6 g (0.049 moles) of trimethylolpropane dissolved at 60° C. in 45 g of butylacetate.

Polymer 3 was thus obtained with:
calculated average number molecular weight=1870;
functionality (F)=2.5.

Polymer 3 was used as additive in the following examples, wherein it is indicated as P-3.

### Polymer 4 (R=1.40)

Polymer 4 was prepared following the same procedure disclosed above for polymer 2, except that the following reagents and amounts were used:
82.0 g (0.369 moles) of isophoronediisocyanate;
9.16 g (0.148 moles) of ethylene glycol instead of
   2,2-dimethyl-1,3-propanediol; and
26.4 g (0.197 moles) of trimethylolpropane dissolved at 60° C. in 50 g of butylacetate.

Polymer 4 was thus obtained with:
calculated average number molecular weight=4300;
functionality (F)=5.3.

Polymer 4 was used as additive in the following examples, wherein it is indicated as P-4.

### Polymer 5 (R=1.71)

Polymer 5 was prepared following the same procedure disclosed above for polymer 2, except that the following reagents and amounts were used:
98.4 g (0.443 moles) of isophoronediisocyanate;
5.02 g (0.037 moles) of 2,2-bis(hydroxymethyl)-1,3-propanediol;
13.8 g (0.221 moles) of ethylene glycol; and
26.1 g (0.197 moles) of trimethylolpropane.

Polymer 5 was thus obtained with:
calculated average number molecular weight=2878;
functionality (F)=4.8.

Polymer 5 was used as additive in the following examples, wherein it is indicated as P-5.

### Example 1

1a—Preparation of a Polyurethane-Based Formulation

5.20 g of Desmophen® XP 2488 were mixed under stirring at room temperature with 8.84 g of Desmodur® N3900, 4.20 g of methoxypropyl-acetate and 0.1 ml of dibutyltin dilaurate solution 1% w/w in butyl acetate, thus obtaining a polyurethane-based formulation (Composition 1).

Each of Polymers 1C and 2 to 5—prepared as detailed in the previous examples—were added to a Composition 1 in suitable amounts, so as to obtain compositions 2 to 11, wherein the concentration of the polymer is as described in Table 1.

1b—Preparation of Coated Supports Using Polyurethane-Based Formulations

Each of the formulations prepared in Example 1 were applied with a doctor blade on three different supports: glass (G), aluminium panel (Al) and polycarbonate (PC). The wet film thickness was 100 microns.

Then, the coatings were dried 10 minutes at room temperature followed by drying in an oven for 40 minutes at 80° C. The resulting dry film thickness was 50 microns.

Static contact angle values (SCA) vs. water and vs. n-hexadecane were measured using DSA30 (Kriss GmbH, Germany) equipment.

The haziness of the coating on glass was evaluated by visual inspection.

The results are reported in Table 1.

### Example 2—Easy Cleanability Testing

A staining agent (bullet tip permanent black marker—Pentel® N50) was put on the surface of the different coated supports prepared following the procedure described in Examples 1b and 2b, for 24 hours at room temperature.

The results are showed in Table 1.

The results show that the dark stain was easily removed using a dry paper sheet in case of coatings prepared using formulations according to the present invention, wherein a PFPE was used as additive. Differently, an indelible stain was observed when coatings were prepared using the comparative formulations (blank formulation 1) free of a PFPE additive.

TABLE 1

| | Additive | | | | | SCA vs. | | | | |
|---|---|---|---|---|---|---|---|---|---|---|
| Compo- | | % | SCA vs. water | | | hexadecane | | | Glass | |
| sition | | w/ | (degree °) | | | (degree °) | | | coating | Stain |
| No. | Type | w | G | Al | PC | G | Al | PC | aspect | test |
| 1(*) | — | — | 81 | 70 | 73 | 20 | 21 | 34 | clear | − |
| 2(*) | P-1C | 1.0 | 100 | 99 | 102 | 68 | 69 | 71 | Light | ++ |
| | | | | | | | | | hazy | |
| 3 | P-2 | 0.5 | 109 | n/p | n/p | 62 | n/p | n/p | clear | ++ |
| 4 | P-2 | 1.0 | 111 | 100 | 100 | 68 | 66 | 68 | clear | ++ |
| 5 | P-3 | 0.5 | 106 | n/p | n/p | 66 | n/p | n/p | clear | ++ |
| 6 | P-3 | 1.0 | 107 | n/p | n/p | 67 | n/p | n/p | clear | ++ |
| 7 | P-4 | 0.5 | 100 | 95 | 91 | 62 | 66 | 58 | clear | ++ |
| 8 | P-4 | 1.0 | 102 | 104 | 106 | 66 | 71 | 64 | clear | ++ |
| 9 | P-5 | 0.5 | 95 | 94 | 97 | 63 | 65 | 60 | clear | ++ |
| 10 | P-5 | 1.0 | 95 | 94 | 98 | 64 | 68 | 64 | clear | ++ |
| 11(*) | P-3 | 5.0 | n/p | n/p | n/p | n/p | n/p | n/p | hazy | n/p |

G = glass
Al = aluminium
PC = polycarbonate
(*)comparative
n/p = not performed
In the stain test:
− stain
+ halo
++ no stain

### Example 3—Easy Cleanability Testing on Fingerprints

The anti-fingerprint test was carried out in accordance to the method MIL C 15074E by using synthetic sebum commercially available (Scientific Services S/D Inc.), having the following composition (wherein the amounts are given as w/w %):

### Palmitic Acid (10%),

### Stearic Acid (5%),

### Coconut Oil (15%),

### Paraffin Wax (10%),

### Synthetic Spermacetti (15%),

### Olive Oil (20%),

### Squalene (5%),

### Cholesterol (5%),

### Oleic Acid (10%) and

### Linoleic Acid (5%).

The procedure was as follows. Different black polycarbonate (PC) coated supports were prepared following the procedure described in Example 1b. A folded cotton bandage (size 30×30 mm) was wetted with synthetic sebum (after melting the composition in oven at 40° C. and shaking before use) and applied on the black PC coated support for 10 seconds, applying a load of 1 kg. Then the black PC coated support was put in oven for 60 minutes at 40° C.

A dry paper sheet was used to clean the fingerprint stain. The results are summarized in Table 2.

TABLE 2

| Composition No. | Anti-fingerprint test |
|---|---|
| 1(*) | − |
| 3 | ++ |
| 4 | ++ |
| 5 | ++ |
| 6 | ++ |

(*)comparative
In the stain test:
− stain
+ halo
++ no stain

1. A hydroxy-terminated (per)fluoropolyether polymer (P) obtained by a process comprising the following steps:
(a) reacting a polymer (P*) with an isocyanate compound (NCO) to form an intermediate compound, wherein polymer (P*) is a (per)fluoropolyether (PFPE) polymer comprising a (per)fluoropolyether chain (R_{pf}) having two chain ends wherein at least one chain end comprises at least one hydroxy group; and
(b) reacting the intermediate compound with at least one compound (OH), wherein compound (OH) is a di-, tri- or tetraol compound,
wherein the ratio between the total number of equivalents of —OH groups derived from said polymer P* and said at least one compound OH and the total number of equivalents of isocyanate groups derived from said compound NCO is greater than 1 and less than 2.

2. The polymer (P) according to claim 1, said polymer (P) comprising:
at least one fluorinated block comprising a (per)fluoropolyether chain (R_{pf}),
at least one end group bearing at least one hydroxy group (OH),
a bridging group (B) between said chain (Rₚ) and said group (OH), comprising
at least one moiety (Z) of formula
—O—C(O)NH—R—NHC(O)—O—
wherein R is an alkyl chain having from 1 to 20 carbon atoms, a 3- to 7-membered aliphatic ring optionally substituted with at least one linear or branched alkyl chain having from 1 to 6 carbon atoms, a 5- to 10-membered aromatic ring optionally substituted with at least one linear or branched alkyl chain having from 1 to 6 carbon atoms, a group comprising two aliphatic or two aromatic rings as defined above linked together via an alkylene chain comprising from 1 to 3 carbon atoms, and
at least one moiety (A), wherein moiety (A) is a di-, tri- or tetravalent alkyl chain having from 1 to 10 carbon atoms, optionally substituted with at least one substituent selected from the group consisting of alkyl group having from 1 to 6 carbon atoms, hydroxy and alkoxy having from 1 to 3 carbon atoms.

3. The polymer (P) according to claim 2, wherein said chain (R_{pf}) is a chain of formula -D-(CFX)ₐO(R_{f})(CFX′)_{b}-D*-, wherein
a and b, equal or different from each other, are equal to or greater than 1;
X and X′, equal or different from each other, are —F or —CF₃,
provided that when a and/or b are greater than 1, then X and X′ are —F;
D and D*, equal or different from each other, are a divalent alkyl chain comprising from 1 to 20 carbon atoms,
said alkyl chain being optionally interrupted by at least one oxygen atom and/or optionally substituted with at least one hydroxy group and/or with a perfluoroalkyl group comprising from 1 to 3 carbon atoms;
(R_{f}) comprises repeating units R^{∘}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

4. The polymer (P) according to claim 2, wherein said bridging group (B) complies with the following formula (B-I): 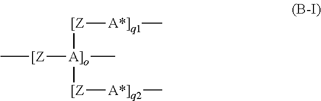
wherein
Z and A are, respectively, moiety (Z) and moiety (A) as defined in claim 2,
A* has the same meanings defined above for A,
∘ is an integer from 1 to 10, and
q1 and q2, identical or different from each other, are 0 or an integer from 1 to 10.

5. The polymer (P) according to claim 4, wherein said moiety (Z) is linked to said chain (R_{pf}), and said moiety (A) is linked to said group (OH).

6. The polymer (P) according to claim 1, wherein polymer (P) complies with formula (P-I): 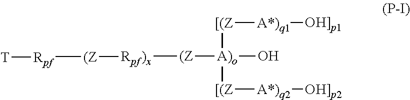
wherein
R_{pf} is a (per)fluoropolyether chain,
Z is at least one moiety (Z) of formula
—O—C(O)NH—R—NHC(O)—O—
wherein R is an alkyl chain having from 1 to 20 carbon atoms, a 3- to 7-membered aliphatic ring optionally substituted with at least one linear or branched alkyl chain having from 1 to 6 carbon atoms, a 5- to 10-membered aromatic ring optionally substituted with at least one linear or branched alkyl chain having from 1 to 6 carbon atoms, a group comprising two aliphatic or two aromatic rings as defined above linked together via an alkylene chain comprising from 1 to 3 carbon atoms,
A is at least one moiety (A), wherein moiety (A) is a di-, tri- or tetravalent alkyl chain having from 1 to 10 carbon atoms, optionally substituted with at least one substituent selected from the group consisting of alkyl group having from 1 to 6 carbon atoms, hydroxy and alkoxy having from 1 to 3 carbon atoms,
A* has the same meanings defined above for A,
∘ is an integer from 1 to 10,
q1 and q2, identical or different from each other, are 0 or an integer from 1 to 10;
x is 0 or an integer from 1 to 4;
p1 and p2, equal or different each other, are 0 or 1; and
T is a neutral group being selected from the group consisting of —H, —F, —Cl, a straight or branched perfluoroalkyl group comprising from 1 to 3 carbon atoms, and groups of formula (T-I): 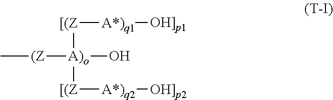
wherein Z, A, A*, ∘, q1, q2, p1 and p2 are as defined above.

7. A composition (S) comprising:
A) from 0.01 to less than 5 wt. %, preferably from 0.05 to 4 wt. % and even more preferably from 0.1 to 2.5 wt. %, based on the total weight of said composition, of at least one polymer (P) according to claim 1;
B) from 5 to 50 wt. % based on the total weight of said composition of at least one binder component;
C) from 30 to 80 wt. % of at least one cross-linker component; and
D) optionally further ingredients.

8. The composition (S) according to claim 7, wherein said binder component comprises at least one hydroxyl-functional binder selected from the group consisting of hydroxyl-functional resins.

9. The composition (S) according to claim 7, wherein said at least one cross-linker component is selected from the group consisting of polyisocyanate cross-linkers, trans-esterification cross-linking agents, amino resin cross-linking agents, melamine-formaldehyde resins; and trisalkoxycarbonylamino-triazine cross-linking agents.

10. The composition (S) according to claim 7, wherein said further ingredients are selected from the group consisting of transparent fillers, volatile or non-volatile additives, binders, catalysts, leveling agents, wetting agents, anticratering agents, dyes, rheology control agents, antioxidants and/or light stabilizers.

11. A surface coating for a substrate, the coating comprising a composition (S) as defined in claim 7.

12. A method for coating at least one surface of a substrate, said method comprising:
(i) contacting a substrate with composition (S) as defined in claim 7 and
(ii) drying said composition (S) onto said substrate.

13. The method according to claim 12, said method providing for a transparent coating onto said at least one surface

14. The method according to claim 12, wherein said substrate is selected from the group consisting of glass; metal-optionally coated with a base coat layer; and plastic.

15. The method according to claim 12, wherein step (ii) is performed by curing composition (S) onto said substrate.

16. The polymer (P) according to claim 3, wherein a and b, equal or different from each other, are from 1 to 10,

17. The polymer (P) according to claim 3, wherein a and b, equal or different from each other, are from 1 to 3.

18. The polymer (P) according to claim 3, wherein D and D*, equal or different from each other, are a divalent alkyl chain comprising from 1 to 6 carbon atoms, said alkyl chain being optionally interrupted by at least one oxygen atom and/or optionally substituted with at least one hydroxy group and/or with a perfluoroalkyl group comprising from 1 to 3 carbon atoms;

19. The polymer (P) according to claim 3, wherein (R_{f}) consists of repeating units R^{∘}, said repeating units being independently selected from the group consisting of:
(i) —CFXO—, wherein X is F or CF₃;
(ii) —CFXCFXO—, wherein X, equal or different at each occurrence, is F or CF₃, with the proviso that at least one of X is —F;
(iii) —CF₂CF₂CW₂O—, wherein each of W, equal or different from each other, are F, Cl, or H;
(iv) —CF₂CF₂CF₂CF₂O—; and
(v) —(CF₂)ⱼ—CFZ—O— wherein j is an integer from 0 to 3 and Z is a group of general formula —O—R_{(f-a)}-T, wherein R_{(f-a)} is a fluoropolyoxyalkene chain comprising a number of repeating units from 0 to 10, said recurring units being selected from: —CFXO—, —CF₂CFXO—, —CF₂CF₂CF₂O—, —CF₂CF₂CF₂CF₂O—, with each of X being independently F or CF₃ and T being a C₁-C₃ perfluoroalkyl group.

20. The polymer (P) according to claim 4, wherein ∘, q1 and q2 are each independently an integer from 1 to 6.
